(19) United States
(12) Patent Application Publication
(10) Pub. No.: US 2010/0096817 A1
(43) Pub. Date: Apr. 22, 2010

(54) ALL-TERRAIN VEHICLE SUSPENSION SYSTEM

(76) Inventor: MU-CHEN HUNG, Kaohsiung Hsien (TW)

Correspondence Address: LEONG C LEI, PMB # 1008, 1867 YGNACIO VALLEY ROAD, WALNUT CREEK, CA, 94598, US

(21) Appl. No.: 12/254,013

(22) Filed: Oct. 20, 2008

(51) Int. Cl. B60G 17/02

(52) U.S. Cl. 280/5.515

(57) ABSTRACT

A suspension system is coupled between a front wheel and a vehicle frame of an all-terrain vehicle, including an inverted A-shaped connection rack and two shock absorbers. The connection rack has an end coupled to the vehicle frame and an opposite end coupled to the wheel. The shock absorbers are coupled to the connection rack in such a way to be set respectively frontward and rearward with respect to each other. An opposite end of each shock absorber is coupled to the vehicle frame. Each shock absorber includes a spring composed of upper, intermediate, and lower sections each having helical turns arranged in such a way that the turns of the upper and lower sections of the spring are sparsely arranged, while the turns of the intermediate section is densely arranged.

### TECHNICAL FIELD OF THE INVENTION

The present invention generally relates to an all-terrain vehicle suspension system, and particularly to a suspension system that provides excellent result of shock absorption and enhanced riding safety when the all-terrain vehicle is traveling through an uneven surface.

### DESCRIPTION OF THE PRIOR ART

To provide stable movement of a four-wheeled all-terrain vehicle, suspension system functioning to absorb shock must be provided, so that when the vehicle is traveling through an even surface, the external vibration/shock caused by the uneven surface can be minimized to provide a rider with better controllability and enhance riding safety for the rider to enjoy the pleasure of riding. A conventional suspension system is illustrated in FIG. 1 of the attached drawings, wherein a suspension arm 11 is provided at a front end of a vehicle frame 1. Opposite ends of the suspension arm 11 are respectively pivoted to shock absorbers 2. Lower ends of the shock absorbers 2 are mounted to a fixation board at the front end of the vehicle frame 1. The shock absorbers 2 are provided with springs 21 that have helical turns in a sparsely arrangement. When the vehicle travels through an uneven surface, the springs 21 of the shock absorbers 2 provide a cushioning effect to reduce the vibration/shock, thereby preventing excessive shocks from affecting the controllability of the rider. Such a structure is effective in absorbing shocks. However, the shock absorbers 2 are provided at both sides of the vehicle and since opposite sides of a road, generally, are not of the same height, shock absorption is often carried out by the shock absorber at one side. In addition, since the spring 21 encompassing the shock absorber is of a substantially uniform and sparse arrangement of the helical turns, the whole spring 21 may quickly become dense of the turns due to the external vibration/shock. Thus, on a severely uneven surface, the absorption of shock may get poor and the shock absorber may easily break, leading to frequent replacement. Apparently, the rider has to take the vibration to a substantial extent, which makes the rider uncomfortable and reduces the controllability, eventually leading to potentially unsafe riding and the need for further improvement.

### SUMMARY OF THE INVENTION

The present inventor has been engaged in the development of all-terrain vehicles for years and has regularly made studies and researches of parts of the all-terrain vehicles to thereby create the present invention in view of the problems associated with the result of shock absorption performed by the state-of-the-art technology.

An objective of the present invention is to provide an all-terrain vehicle suspension system that provides the all-terrain vehicle with excellent result of shock absorption when the all-terrain vehicle travels through an uneven road surface, so as to improve riding controllability and thus enhance riding safety.

The suspension system of the present invention is coupled between a wheel body of a front wheel and a vehicle frame of an all-terrain vehicle and comprises an inverted A-shaped connection rack and two shock absorbers. The connection rack has an end portion coupled to the vehicle frame and an opposite end portion coupled to the wheel body. The two shock absorbers are coupled to the connection rack at locations close to the wheel body in such a way that the shock absorbers are set respectively frontward and rearward with respect to each other. An opposite end of each shock absorber is pivotally coupled to the vehicle frame. Each shock absorber comprises a spring composed of upper, intermediate, and lower sections each having a plurality of helical turns arranged in such a way that the turns of the upper and lower sections of the spring are sparsely arranged, while the turns of the intermediate section is densely arranged. Thus, when the vehicle travels through an uneven road surface, shock absorption can be effectively enhanced by the two frontward- and rearward-located shock absorbers and the intermediate-section-densely-arranged and upper/lower-section-sparely-arranged spring configuration to thereby enhance riding safety and pleasure.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a conventional suspension system.

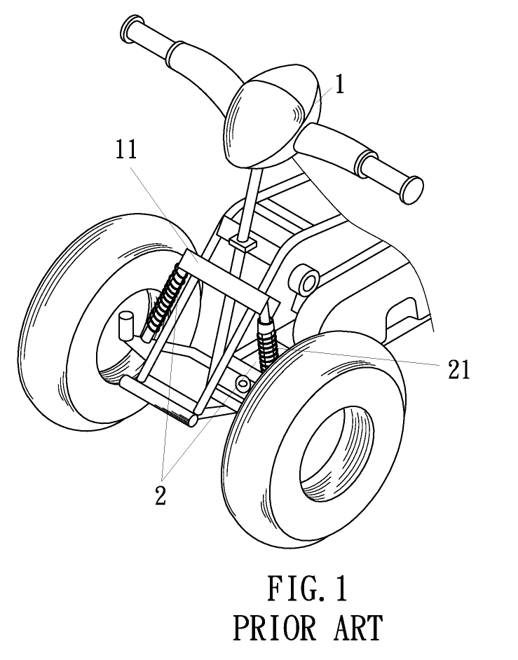

FIG. 2 is a perspective view of a preferred embodiment of the present invention.

FIG. 3 is an exploded view of the present invention, as well as a vehicle frame.

FIG. 4 is a front view, partially broken, of a shock absorber in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

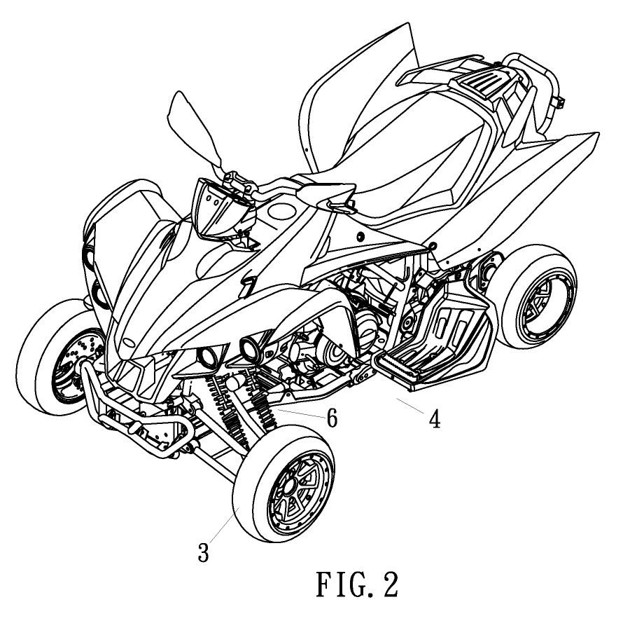

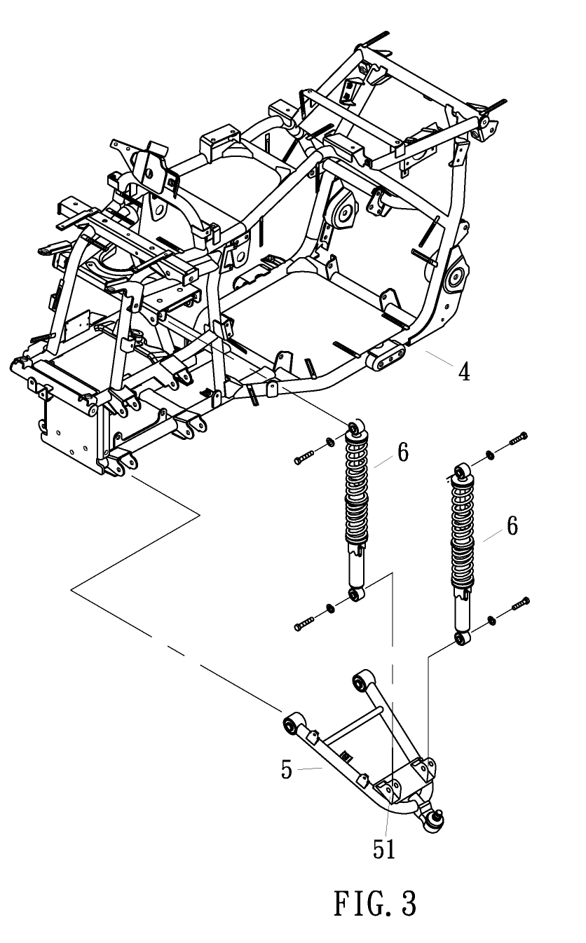

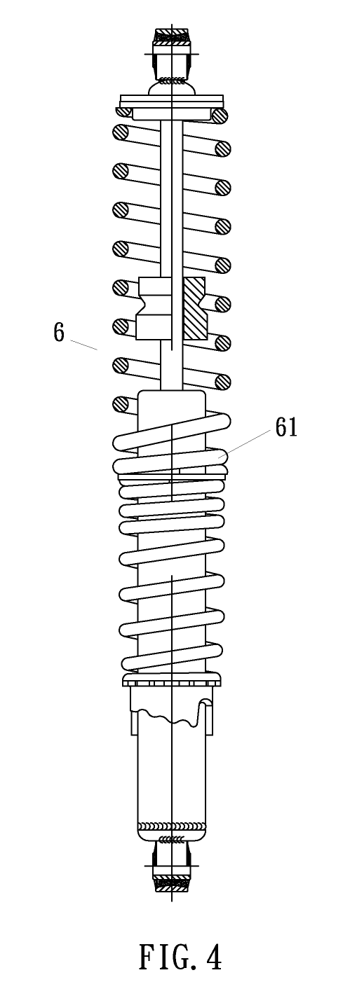

With reference to FIGS. 2-4, a suspension system in accordance with the present invention is coupled between a wheel body 3 of front wheels and a vehicle frame 4 of an all-terrain vehicle. As shown, the suspension system is comprised of an inverted A-shaped connection rack 5 and two shock absorbers 6. An end portion of the connection rack 5 is coupled to the vehicle frame 4 and an opposite end portion is coupled to the wheel body. The connection rack 5 forms two spaced positioning frames 51 at locations close to the wheel body 3 to pivotally connect the two shock absorbers 6 in such a way that the shock absorbers are respectively located frontward and rearward with respect to each other. An opposite end of each shock absorber 6 is coupled to the vehicle frame 4 to complete the assembling. A circumferential surface of each shock absorber 6 is encompassed by a spring 61, such as a helical spring, including an upper section, an intermediate section, and a lower section each comprising helical turns of the spring in such a way that the turns of the upper and lower sections are sparsely arranged, namely spaced from each other, and the turns of the intermediate section are densely arranged, namely close to each other.

When the vehicle travels through an uneven road surface, the frontward shock absorber 6 first operate to perform shock absorption and then the rearward shock absorber 6 effects shock absorption. In other words, shock absorption is successively performed in a front-to-rear manner. Meanwhile, when the shock absorbers 6 operate due to the uneven road surface, the sparsely arranged lower section of the spring 61 is cause to get dense by making the turns close to each other and the densely arranged intermediate section of the spring 61 provides a buffering effect to allow the sparsely arranged upper section of the spring 61 to provide shock absorption effect subsequently. In this way, the suspension system of the present invention can provide multiple shock absorption and thus enhances the effect of shock absorption, minimizing the influence of the external vibration so as to provide a rider with improved controllability, improve riding safety, and make the riding comfortable to the rider due to the reduced external vibration to thereby increase the pleasure of riding the vehicle.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A suspension system adapted to couple between a wheel body of front wheels and a vehicle frame of an all-terrain vehicle, the suspension system comprising an inverted A-shaped connection rack and two shock absorbers, the connection rack having an end portion coupled to the vehicle frame and an opposite end portion coupled to the wheel body, the connection rack forming two positioning frames at locations close to the wheel body for pivotally connecting the two shock absorbers in such a way that the shock absorbers are set respectively frontward and rearward with respect to each other, an opposite end of each shock absorber being coupled to the vehicle frame, each shock absorber being encompassed by a spring composed of upper, intermediate, and lower sections each having a plurality of helical turns arranged in such a way that the turns of the upper and lower sections of the spring are sparsely arranged, while the turns of the intermediate section is densely arranged.
